(19) United States
(12) Patent Application Publication
(10) Pub. No.: US 2014/0354678 A1
(43) Pub. Date: Dec. 4, 2014

(54) DISPLAY CONTROL METHOD AND DISPLAY DEVICE USING THE DISPLAY CONTROL METHOD

(71) Applicant: Fitipower Integrated Technology, Inc., Hsinchu City (TW)

(72) Inventor: CHONG-XING WANG, Hsinchu (TW)

(73) Assignee: Fitipower Integrated Technology, Inc., Hsinchu City (TW)

(21) Appl. No.: 14/140,578

(22) Filed: Dec. 26, 2013

(30) Foreign Application Priority Data
Jun. 3, 2013 (TW) 102119674

(51) Int. Cl. G09G 5/02

(52) U.S. Cl. CPC G09G 5/02
USPC 345/600

(57) ABSTRACT

A display control method of a display device having a color engine. A mode setting interface is started which comprises an option for setting a working status of the color engine. When the option is operated, the color engine setting interface is started. A working status of the color engine is set via the color engine setting interface. When the color engine is in an active status, the color engine is controlled to process content to be displayed.

### BACKGROUND

1. Technical Field

The present disclosure relates to a display control method and a display device using the display control method.

2. Description of Related Art

A color engine which is also called a color management module (CMM) is widely used in display devices, such as smart phones, tablets, or personal computers. The color engine processes content (e.g., images and texts) displayed on the display devices to make the displayed images sharper and clearer. However, even if the displayed content (e.g., texts) does not include image data, the color engine will still process the displayed content to confirm whether any image data is displayed on the display device. When the user is viewing information (e.g., texts) which does not include image data, the color engine cannot be manually turned off and will continue to work. Thus, there is unnecessary power consumption of the display device.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an embodiment of a display device having a display control system.

FIG. 2 shows an embodiment of a mode setting interface of the display device of FIG. 1.

FIG. 3 shows an embodiment of a color engine setting interface of the display device of FIG. 1.

FIG. 4 is a flowchart of one embodiment of a control method of the display device of FIG. 1.

### DETAILED DESCRIPTION

Reference will be made to the drawings to describe various embodiments.

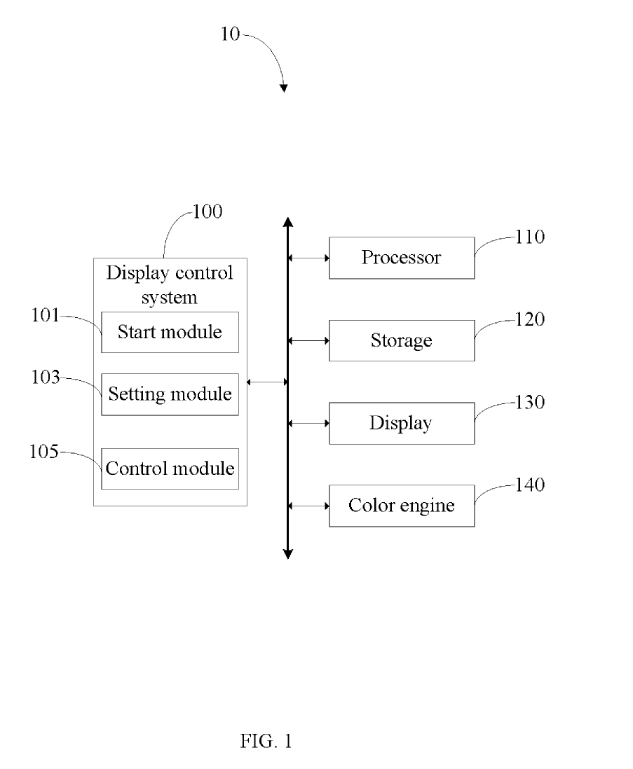

FIG. 1 is a schematic block diagram of an embodiment of a display device 10 including a display control system 100, a processor 110, a storage 120, a display 130, and a color engine 140. The display device 10 can be a smart phone, a mobile internet device (MID), or other similar device. The touch display device 10 can include more or fewer components than those shown in the embodiment of FIG. 1, or have a different component configuration. The color engine 140 converts RGB color space of an image to HIS color space, which R represents red, G represents green, B represents blue, H represents hue, S represents saturation, and I represents intensity. The color engine 140 modulates hue, saturation, or intensity of the image displayed on the display 130 to make the image sharper, clearer, and increase the quality of the image.

The display control system 100 can include a plurality of programs in the form of one or more computerized instructions stored in the storage 120 and executed by the processor 110 to perform operations of the display device 10. In the embodiment, the display control system comprises a start module 101, a setting module 103, and a control module 105. In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

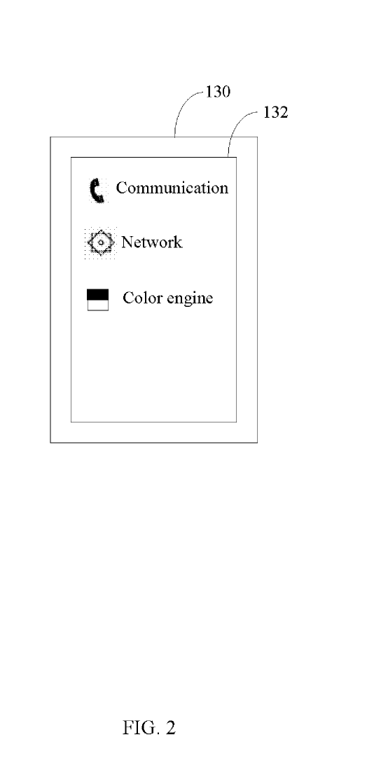

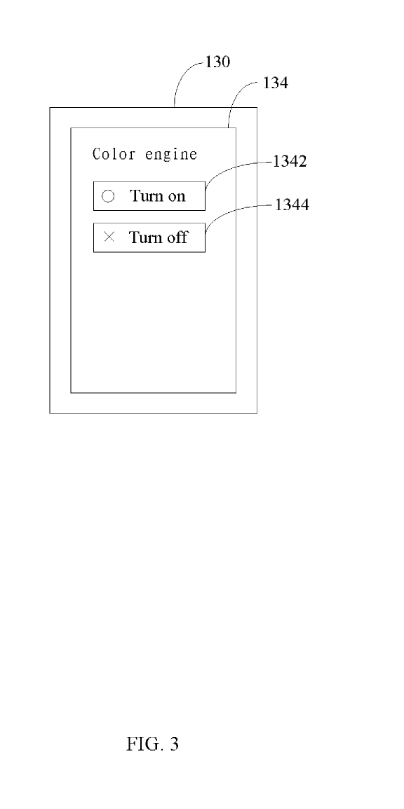

The start module 101 starts a mode setting interface 132, which comprises an option for setting a working status of the color engine 140. The mode setting interface 132 can comprise a plurality of options. In FIG. 2, the plurality of options include “communication setting,” “network setting,” and “color engine setting,” or the like. When the option of the color engine setting is selected, a color engine setting interface 134 is started as shown in FIG. 3.

The setting module 103 sets a working status of the color engine 140 via the color engine setting interface 134. The working status of the color engine comprises an active status and an inactive status. In the embodiment, the color engine setting interface 134 comprises a first icon 1342 and a second icon 1344. When the first icon 1342 is operated (e.g., clicked or touched), the color engine 140 is set to the active status. When the second icon 1344 is operated (e.g., clicked or touched), the color engine 140 is set to the inactive status.

The control module 105 controls the color engine 140 to work at the set status. In the embodiment, when the set status is in the active status, the control module 105 activates the color engine 140 to process content such as text and images to be displayed. When the set status is in the inactive status, the color engine 140 is turned off by the control module 105 and works in the inactive status. At this time, the color engine 140 does not process the content.

In the embodiment, the display 130 is a touch screen.

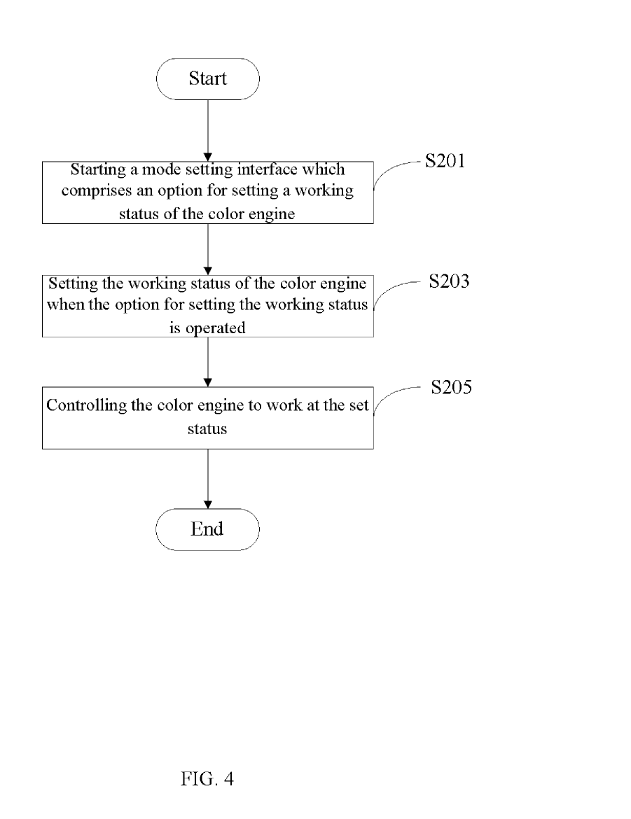

FIG. 4 shows a flowchart of one embodiment of a control method of the display device 10. Depending on the embodiment, additional steps may be added, others removed, and the ordering of the steps may be changed.

In step S201, the start module 101 starts a mode setting interface 132 which comprises an option of color engine setting. When the option of the color engine setting is selected, step S203 is performed.

In step S203, the setting module 103 sets a working status of the color engine 140 via the color engine setting interface 134. The working status of the color engine 140 comprises an active status and an inactive status. When the first icon 1342 is operated (e.g., clicked or touched), the color engine 140 is set to the active status. When the second icon 1344 is operated (e.g., clicked or touched), the color engine 140 is set to the inactive status.

In step S205, the control module 105 controls the color engine 140 to work at the set status. In this embodiment, when the set status is in the active status, the control module 105 activates the color engine to process content such as texts and images to be displayed. When the set status is in the inactive status, the color engine 140 is turned off by the control module 105 and works in the inactive status, and the color engine 140 does not process the content.

In summary, the control method for the display device 10 can be used to manually set the working status of the color engine according to requirements. Thus the color engine is set to the inactive status; the display device consumes less power.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A display device, comprising:
a processor;
a display;
a storage;
a color engine converting RGB color space of an image into HIS color space, where R represents red, G represents green, B represents blue, H represents hue, S represents saturation, and I represents intensity, and configured for modulating hue, saturation, or intensity of the image displayed on the display to make the images displayed on the display device sharper and clearer; and
one or more programs stored in the storage and executed by the processor, the one or more programs comprising:
a start module starting a mode setting interface which comprises an option for setting a working status of the color engine;
a setting module setting the working status of the color engine when the option for setting the working status is operated; and
a control module controlling the color engine to work at the set status.

2. The display device of claim 1, wherein the display device further comprises a color engine setting interface configured to set the working status of the color engine, and the color engine setting interface is activated when the option is operated.

3. The display device of claim 2, wherein the working status of the color engine comprises an active status and an inactive status.

4. The display device of claim 3, wherein when the set status is in the active status, the control module actives the color engine to process content to be displayed on the display.

5. The display device of claim 3, wherein when the set status is in the inactive status, the color engine is turned off by the control module and does not process the content.

6. The display device of claim 3, wherein the color engine setting interface comprises a first icon and a second icon, the color engine is set to the active status when the first icon is operated and the color engine is set to the inactive status when the second icon is operated.

7. A control method of a display device having a color engine which converts RGB color space of an image into HIS color space, where R represents red, G represents green, B represents blue, H represents hue, S represents saturation, and I represents intensity, and configured for modulating hue, saturation, or intensity of the image displayed on the display to make the images displayed on the display device sharper and clearer, the method comprising:
starting a mode setting interface which comprises an option for setting a working status of the color engine;
setting the working status of the color engine when the option for setting the working status is operated; and
controlling the color engine to work at the set status.

8. The control method of claim 7, wherein the step of setting the working status of the color engine comprises activating a color engine setting interface for setting the working status of the color engine when the option is operated.

9. The control method of claim 8, wherein the working status of the color engine comprises an active status and an inactive status.

10. The display device of claim 9, wherein in the step of controlling the color engine to work at the set status comprises controlling the color engine to work in the active status to process content to be displayed by the display device when the set status is in the active status.

11. The display device of claim 9, wherein in the step of controlling the color engine to work at the set status comprises turning off the color engine to control the color engine to not process content to be displayed by the display device.
